(19) United States
(12) Patent Application Publication
(10) Pub. No.: US 2026/0180431 A1
(43) Pub. Date: Jun. 25, 2026

(54) APPARATUS AND METHOD FOR PREVENTING OVERCURRENT IN GRID-FORMING INVERTER

(71) Applicant: INDUSTRY-ACADEMIC COOPERATION FOUNDATION, YONSEI UNIVERSITY, Seoul (KR)

(72) Inventors: Jung-Wook PARK, Seoul (KR); Tae Yoon KIM, Jeju-si (KR)

(21) Appl. No.: 19/013,372

(22) Filed: Jan. 8, 2025

(30) Foreign Application Priority Data
Dec. 23, 2024 (KR) 10-2024-0193496

(51) Int. Cl. H02M 1/32; H02J 3/01

(52) U.S. Cl. CPC H02M 1/32; H02J 3/01

(57) ABSTRACT

An embodiment provides an apparatus and method for preventing overcurrent in a grid-forming inverter. An apparatus according to the embodiment includes: a power calculation unit for measuring active power and reactive power for a connection point in real time; a second droop unit for determining a voltage setting value of a grid-forming inverter using the measured reactive power; and a first droop unit for determining a phase angle of the grid-forming inverter so that the measured active power follows a pre-specified active power limit value when the active power limit value is lower than or equal to the measured active power.

### CROSS REFERENCE TO RELATED APPLICATION

The present application claims priority to Korean Patent Application No. 10-2024-0193496, filed Dec. 23, 2024, in the Korean Intellectual Property Office, the entire contents of which are incorporated herein for all purposes by this reference.

### BACKGROUND

The disclosure relates to a grid-forming inverter, and more specifically, to an apparatus and method for preventing overcurrent in a grid-forming inverter.

Currently, South Korea is replacing existing synchronous power plants with inverter-based resources to implement the carbon neutral policy by 2050. However, as inverter-based resources are replaced, the inertia and reserve power of a power system decrease, which reduces the frequency stability of the power system, making it difficult to respond quickly when an accident occurs.

To solve these difficulties, research on various inverter control methods are actively being conducted, and representative inverter control methods include grid-following (hereinafter, referred to as “GFL”) and grid-forming (hereinafter, referred to as “GFM”).

Here, a grid-following inverter uses a phase-locked loop (PLL) to control the current based on the voltage phase angle of a power system. Therefore, the overcurrent does not occur because grid-f inverter control the inverter current output.

In contrast, a grid-forming inverter, which does not use the PLL, controls the current based on its own voltage and phase angle. Therefore, if a frequency drops rapidly, there is a problem that a large phase angle difference occurs between the voltage of the grid-forming inverter and the voltage of the power system, causing excessive current to flow.

Therefore, a solution to solve this problem is needed.

### SUMMARY

An aspect of the disclosure is to propose an apparatus and method for preventing overcurrent in a grid-forming inverter.

The aspect of the disclosure is not limited to that mentioned above, and other aspects not mentioned will be clearly understood by those skilled in the art from the description below.

An apparatus for preventing overcurrent in a grid-forming inverter of the disclosure includes: a power calculation unit for measuring active power and reactive power for a connection point in real time; a second droop unit for determining a voltage setting value of a grid-forming inverter using the measured reactive power; and a first droop unit for determining a phase angle of the grid-forming inverter so that the measured active power follows a pre-specified active power limit value if the active power limit value is lower than or equal to the measured active power.

A method for preventing overcurrent in a grid-forming inverter of the disclosure includes: measuring active power and reactive power for a connection point in real time by a power calculation unit; determining a voltage setting value of a grid-forming inverter using the measured reactive power by a second droop unit; and determining, by a first droop unit, a phase angle of the grid-forming inverter so that the measured active power follows the active power limit value if a pre-specified active power limit value is lower than or equal to the measured active power.

An effect of the disclosure is to prevent overcurrent in a grid-forming inverter and thereby improve the frequency stability of a power system.

Another effect of the disclosure is to prevent overcurrent in a grid-forming inverter and to maintain output at a limit value, thereby improving the frequency stability of a power system.

The effects of the disclosure are not limited to the effects described above, and should be understood to include all effects that are inferable from the configuration of the disclosure described in the detailed description or claims of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A to 1C are circuit diagrams illustrating general grid-forming control techniques;

FIG. 2 is a circuit diagram illustrating a grid-forming control technique according to an embodiment of the disclosure;

FIG. 3 is a circuit diagram illustrating an inverter and an energy storage apparatus connected using a grid-forming control technique according to an embodiment of the disclosure;

FIG. 4 is graphs illustrating comparison results between a grid-forming control technique according to an embodiment of the disclosure and general grid-forming control techniques; and

FIG. 5 is a flow chart illustrating output control in a grid-forming inverter according to an embodiment of the disclosure.

### DETAILED DESCRIPTION

Hereinafter, the disclosure will be described with reference to the accompanying drawings. However, the disclosure may be implemented in various different forms, and therefore is not limited to the embodiments described herein. In addition, in order to clearly describe the disclosure in the drawings, parts that are not related to the description are omitted, and similar parts are given similar drawing reference numerals throughout the specification.

In the entire specification, when a part is said to be “connected (linked, contacted, coupled)” to another part, this includes not only the case where it is “directly connected” but also the case where it is “indirectly connected” with another member in between. In addition, when a part such as a layer, film, region, or plate is said to be “on” another part, this includes not only the case where it is “directly on” another part, but also the case where there is another part in between.

The terms used in this specification are used only to describe specific embodiments and are not intended to limit the disclosure. The singular expression includes the plural expression unless the context clearly indicates otherwise. In this specification, the terms “include” or “have” are intended to specify the presence of a feature, number, step, operation, component, part, or combination thereof described in the specification, but should be understood as not excluding in advance the possibility of the presence or addition of one or more other features, numbers, steps, operations, components, parts, or combinations thereof.

Hereinafter, embodiments of the disclosure will be described in detail with reference to the accompanying drawings.

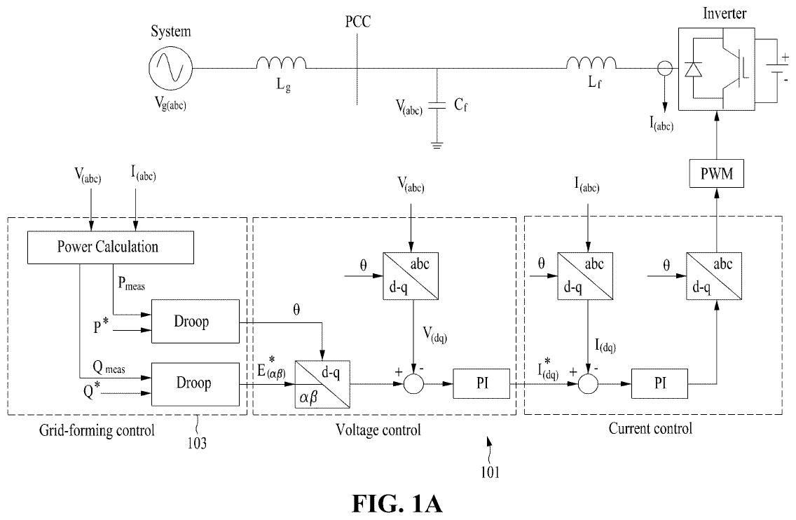

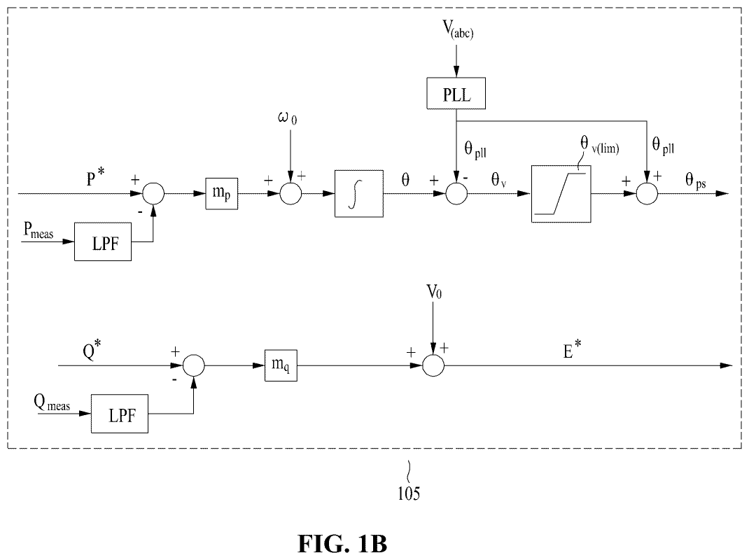

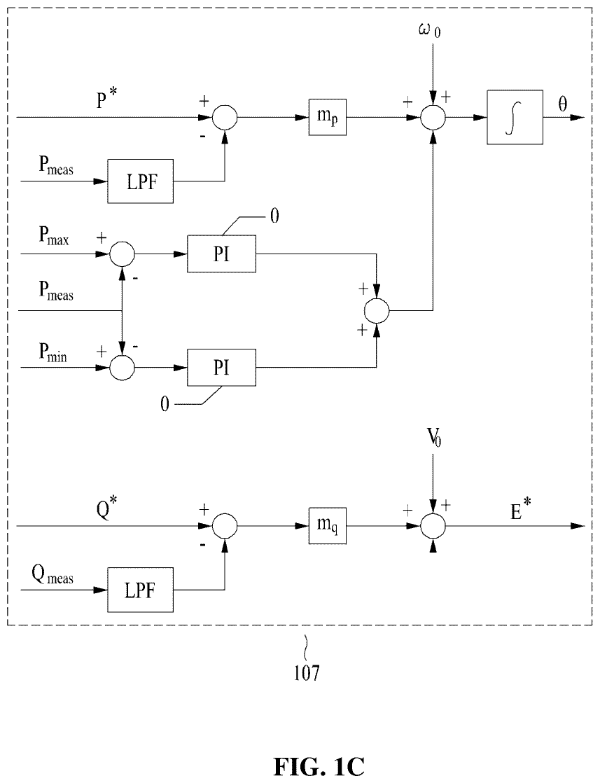

FIGS. 1A to 1C are circuit diagrams illustrating general grid-forming control techniques.

A circuit diagram 101 illustrated in FIG. 1A includes a power system, an output filter, and a grid-forming inverter. Looking at each component, the power system is a power source required to supply power generated by the grid-forming inverter. The output filter suppresses harmonics output from the grid-forming inverter to improve the quality to a sine wave. In the disclosure, an output filter uses an LCL filter composed of two inductors L and one capacitor C, but other configurations may also be used. For example, the output filter may use an LC filter composed of one inductor and one capacitor.

The grid-forming inverter includes a DC power supply, an inverter body, and a grid-forming inverter controller 103. The DC power supply supplies DC voltage and may be any one of a solar panel, a battery, and a fuel cell. The inverter body converts DC power into AC power using power electronics. The inverter body may include a semiconductor switch and a pulse width modulation (PWM). The semiconductor switch may be an insulated gate bipolar transistor (IGBT) or a SiC MOSFET. The PWM generates a desired AC voltage and frequency by opening and closing the semiconductor switch.

The grid-forming inverter controller controls an output voltage and frequency in real time to ensure power grid stability. The grid-forming inverter controller includes a grid-forming control unit 103, a voltage control unit, and a current control unit.

Looking at each component, the grid-forming control unit 103 adjusts the voltage, frequency, active power P and reactive power Q in real time, and maintains the dynamic stability of a power grid. For example, the grid-forming control unit 103 may calculate and output active power Pₘₑₐₛ and reactive power Qₘₑₐₛ using an output voltage V_{abc} and output current I_{abc} output in real time from the grid-forming inverter through a power calculation unit. In addition, the grid-forming control unit 103 may determine and output a phase angle θ of an inverter using active power and an active power setting value P* through a first droop control unit. In addition, the grid-forming control unit 103 may determine and output a voltage setting value E* of an inverter using reactive power and a reactive power setting value Q* through a second droop unit.

The voltage control unit compensates for the voltage deviation caused by the droop characteristic of the grid-forming control unit 103 in the long term. The current control unit compensates for the current deviation caused by the droop characteristic of the grid-forming control unit 103 in the long term.

This grid-forming inverter controls the current based on its own voltage and phase angle. Therefore, if the frequency drops rapidly, there is a disadvantage that a large phase difference occurs between the voltage of the grid-forming inverter and the voltage of a power system, causing excessive current to flow.

In order to prevent such excessive current, various current control techniques have been developed, and representative current control techniques include a phase angle-based grid-forming control technique and an output-based grid-forming control technique.

FIG. 1B is a circuit diagram 105 for first and second droop units of a grid-forming control unit 105 to which a general phase angle-based grid-forming control technique is applied. For example, the phase angle-based grid-forming control technique may be a technique for controlling the current of a grid-forming inverter by controlling the phase angle.

Referring to the circuit diagram 105 illustrated in FIG. 1B, the first droop unit of the grid-forming control determines and outputs a new phase angle θ′ₚₛ by using a difference θᵥ between a phase angle θ generated through the grid-forming control and a phase angle θₚₗₗ of a common coupling point (hereinafter referred to as PCC). The phase angle-based grid-forming control technique controls the current of the grid-forming inverter based on the output phase angle.

However, the phase angle-based grid-forming control technique has a disadvantage in that control is not properly made when overcurrent occurs because the phase angle generated through the grid-forming control is controlled faster than the phase angle of a PCC connection point. In addition, when the difference θᵥ reaches the preset difference limit value θᵥ₍ₗᵢₘ₎, an accumulated error is accumulated due to an integral controller, and there is a fatal disadvantage that the output suddenly and sharply drops due to the accumulated error when the frequency is recovered.

FIG. 1C is a circuit diagram 107 for first and second droop units of a grid-forming control unit 105 to which a general output-based grid-forming control technique is applied. For example, the output-based grid-forming control technique may be a technique that presets the maximum output and minimum output and controls the output between the minimum output and the maximum output.

Referring to the circuit diagram 107 illustrated in FIG. 1C, the first droop unit of the grid-forming control unit determines the phase angle θ by using active power Pₘₑₐₛ, an active power maximum value Pₘₐₓ, an active power minimum value Pₘᵢₙ, and an active power setting value measured at a grid coupling point (or connection point), and outputs the phase angle. The output-based grid-forming control technique controls the current of the grid-forming inverter based on the output phase angle.

However, the output-based grid-forming control technique controls the current so as not to exceed the maximum current value, but has a disadvantage that the output decreases when the frequency is recovered. Due to this disadvantage, when the grid-forming inverter to which the output-based grid-forming control technique is applied is connected to an energy storage apparatus (Energy Storage System, hereinafter referred to as ESS), the output is limited and this is not effective in improving the frequency stability.

Therefore, a solution to solve this disadvantage is required.

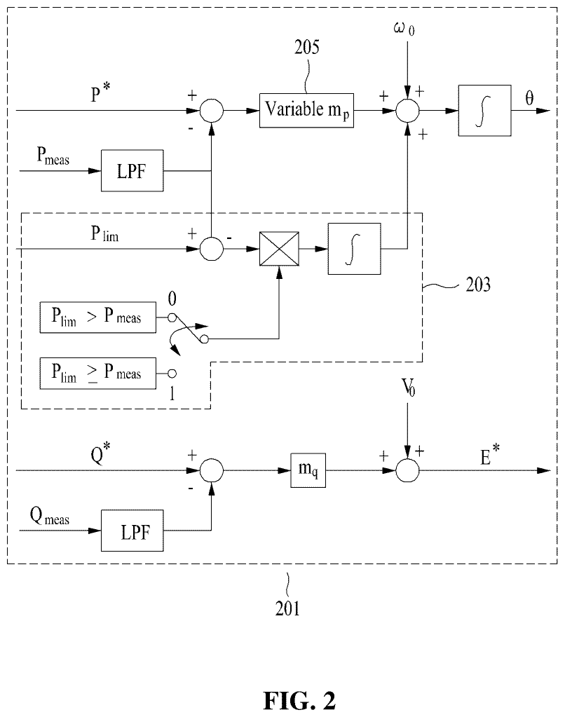

FIG. 2 is a circuit diagram illustrating a grid-forming control technique according to an embodiment of the disclosure. For example, the grid-forming control technique according to an embodiment of the disclosure may be a technique that constantly controls the output using a preset output limit value.

Referring to the circuit diagram 201 illustrated in FIG. 2, the grid-forming control unit includes a first droop unit and a second droop unit.

The second droop unit includes a low-pass filter (hereinafter, referred to as LPF), a reactive power difference calculation unit directly connected to the low-pass filter, a second droop control unit directly connected to the reactive power difference calculation unit, and an inverter voltage calculation unit directly connected to the second droop control unit.

The second droop unit outputs reactive power Qₘₑₐₛ measured at a grid coupling point to the low-pass filter. For example, the reactive power may be calculated through a power calculation unit (not shown). In addition, the second droop unit filters the reactive power through the low-pass filter to generate filtered reactive power, and outputs the filtered reactive power to the reactive power difference calculation unit. In addition, the second droop unit determines a reactive power difference by subtracting the filtered reactive power from a reactive power setting value Q* through the reactive power difference calculation unit, and outputs the determined reactive power difference to the second droop control unit.

In addition, the second droop unit applies a reactive power droop gain m_{q} to the reactive power difference determined through the second droop control unit to generate a corrected reactive power difference, and outputs the corrected reactive power difference to the inverter voltage calculation unit. In addition, the second droop unit adds a voltage setting value V₀ to the corrected reactive power difference through the inverter voltage calculation unit to generate a voltage setting value E* of the inverter, and outputs the generated voltage setting value of the inverter to a voltage control unit (not shown).

The first droop unit includes a low-pass filter, an active power difference calculation unit and an integral controller 203 directly connected to the low-pass filter, a first droop control unit 205 directly connected to the active power difference calculation unit, a frequency calculation unit directly connected to the first droop control unit 205 and the integral controller, and a frequency integrator directly connected to the frequency calculation unit. The integral controller 203 includes an active power comparison unit, a switch connection unit directly connected to the active power comparison unit, and an active power integrator directly connected to the switch connection unit.

The first droop unit outputs the active power Pₘₑₐₛ measured at the grid coupling point to a low-pass filter. For example, the active power may be calculated through a power calculation unit (not shown). In addition, the first droop unit filters the active power through a low-pass filter to generate filtered active power, and outputs the filtered active power to the active power difference calculation unit and the integral controller (Integral Control, hereinafter referred to as “I-controller”) 203.

The integral controller 203 receives the filtered active power from the low-pass filter, and outputs the filtered active power to the active power comparison unit. The integral controller 203 determines active power limit difference by subtracting the filtered active power from an active power limit value set in advance through the active power comparison unit, and outputs the determined active power limit difference to the switch connection unit. For example, the active power limit value may be set through mathematical equation 1 below.

$${P}_{lim} = \sqrt{\frac{9}{4} ( {V}_{d}^{2} + {V}_{q}^{2} ) ( {I}_{d ( lim )}^{2} + {I}_{q ( lim )}^{2} ) - {Q}_{m e o s}^{2}} = \sqrt{\frac{9}{4} ( {V}_{d}^{2} + {V}_{q}^{2} ) ( {I}_{lim}^{2} ) - {Q}_{m e a s}^{2}} \qquad [ Mathematical equation 1 ]$$

Here, Pₗᵢₘ may represent an active power limit value, V_{d} may represent a connection point d-axis voltage, and V_{q} may represent a connection point q-axis voltage. I_{d(lim)} may represent an inverter d-axis current limit value, I_{q(lim)} may represent an inverter q-axis current limit value, Iₗᵢₘ may represent an inverter current limit value, and Qₘₑₐₛ may represent reactive power measured at a connection point.

In addition, the integral controller 203 determines that the active power limit value exceeds the filtered active power if the active power limit difference is positive through the switch connection unit, and turns off the switch so that the active power comparison unit and the active power integrator are disconnected. In addition, the integral controller 203 determines that the active power limit value is less than or equal to the filtered active power if the active power limit difference is 0 or negative through the switch connection unit, and turns on the switch so that the active power comparison unit and the active power integrator are connected, and outputs the active power limit difference to the active power integrator. In addition, the integral controller 203 accumulatively calculates the active power limit difference through the active power integrator, and outputs the accumulatively calculated active power limit difference to the frequency calculation unit.

In addition, the first droop unit determines the active power difference by subtracting the filtered active power from the pre-specified active power setting value P* through the active power difference calculation unit, and outputs the determined active power difference to the first droop control unit 205. In addition, the first droop unit applies the variable active power droop gain, Variable mₚ, to the active power difference determined through the first droop control unit 205 to generate a corrected active power difference, and outputs the corrected active power difference to the frequency calculation unit. Here, the variable active power droop gain is set through small signal stability analysis to prevent overshoot. For example, the characteristic equation is expressed as mathematical equation 2, and the variable active power droop gain may be calculated by applying the root locus technique to mathematical equation 2.

$${s}^{3} + \frac{2 {ω}_{c} Z + \frac{3}{2} {m}_{q} {ω}_{c} {V}_{g} sin δ}{{Z}_{g}} {s}^{2} + \frac{Z {ω}_{c}^{2} + \frac{3}{2} {m}_{p} {ω}_{c} {V}_{g}^{2} sin δ + \frac{3}{2} {m}_{q} {ω}_{c}^{2} {V}_{g} sin δ}{{Z}_{g}} s + \frac{\frac{3}{2} {m}_{p} {ω}_{c}^{2} {V}_{g}^{2} Z sin δ + \frac{9}{4} {m}_{p} {m}_{q} {ω}_{c}^{2} {V}_{g}^{3}}{{Z}_{g}^{2}} = 0 \qquad [ Mathematical equation 2 ]$$

Here, Z_{g} may represent power system impedance, V_{g} may represent a power system voltage, and V may represent a connection point voltage. ω_{c} may represent a cutoff frequency, δ may represent an impedance phase angle, mₚ may represent an active power droop gain, and m_{q} may represent a reactive power droop gain.

In addition, the first droop unit adds a resonance angular frequency (ω₀) and the corrected active power difference to the accumulatively calculated active power limit difference through the frequency calculation unit to determine an omega, and outputs the determined the omega to the frequency integrator. At this time, if the accumulatively calculated active power limit difference exceeds the filtered active power, the active power integrator does not operate (is disable) and is not input to the frequency calculation unit, and if the active power limit value is less than or equal to the filtered active power, the active power integrator operates (is enable) and is input to the frequency calculation unit.

That is, when the active power limit value exceeds the filtered active power, the frequency calculation unit determines the omega by adding the difference between the resonance angular frequency and the corrected active power. In contrast, when the active power limit value is less than or equal to the filtered active power, the frequency calculation unit determines the omega by adding a resonance angular frequency, the compensated active power difference, and the accumulatively calculated active power limit difference. Likewise, when the active power limit value is less than or equal to the filtered active power, the omega is determined by considering the accumulatively calculated active power limit difference, so that the active power gradually follows the active power limit value.

In addition, the first droop unit determines a phase angle θ by integrating the omega through the frequency integrator, and outputs the determined phase angle to the voltage control unit (not shown).

Through the above configuration, an embodiment of the disclosure may prevent overcurrent in a grid-forming inverter and improve the stability of a power system. In addition, an embodiment of the disclosure may prevent overcurrent in a grid-forming inverter and provide stable output to improve the frequency stability of a power system.

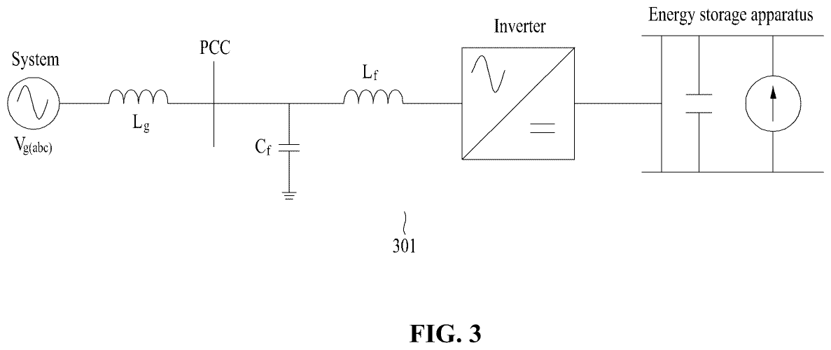

FIG. 3 is a circuit diagram of a grid-forming inverter and an energy storage apparatus connected using a grid-forming control technique according to an embodiment of the disclosure.

Referring to FIG. 3, the circuit diagram 301 includes a power system, an output filter connected to the power system, a grid-forming inverter connected to the output filter, and an energy storage apparatus connected to the grid-forming inverter. Here, the grid-forming inverter operates according to the grid-forming control technique proposed in the disclosure.

In order to compare the performance between the grid-forming control technique according to an embodiment of the disclosure and general grid-forming control techniques, in FIG. 3, the grid-forming inverter is operated by the existing grid-forming control technique proposed in FIG. 1A, the phase angle-based grid-forming control technique proposed in FIG. 1B, the output-based grid-forming control technique proposed in FIG. 1C, and the grid-forming control technique proposed in the disclosure, respectively.

In order to verify the degree to which the grid-forming control technique proposed in the disclosure contributes to frequency stability, an experiment is conducted assuming that the acceptance rate of inverter-based regenerative power sources in the IEEE 39 bus system is 40%.

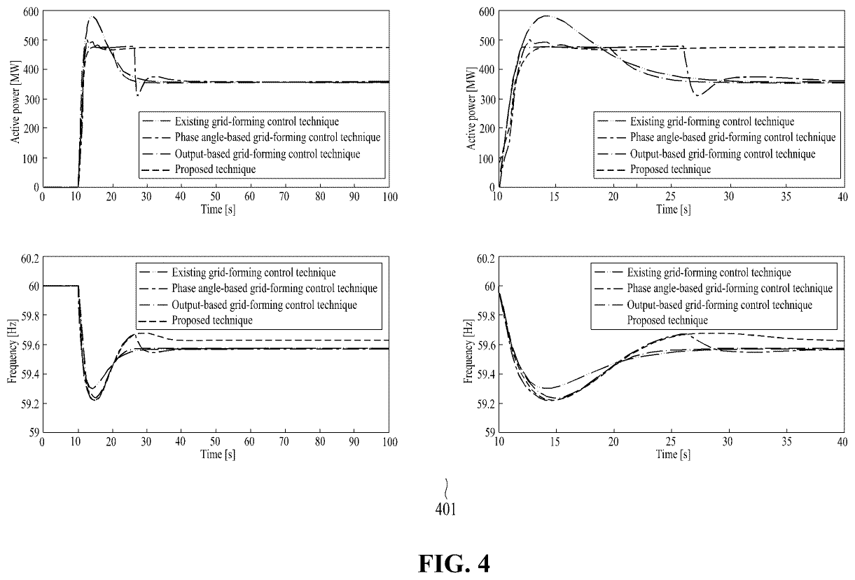

FIG. 4 is graphs illustrating comparison results between a grid-forming control technique according to an embodiment of the disclosure and general grid-forming control techniques.

Looking at the graphs 401 shown in FIG. 4, it is possible to confirm that the grid-forming control technique according to an embodiment of the disclosure may provide an output more continuously compared to general grid-forming control techniques when an accident occurs in a power system. In addition, it is possible to confirm that the settling frequency is improved by 0.06 Hz, 0.06 Hz, and 0.06 Hz, respectively, compared to the existing grid-forming control technique, phase angle-based grid-forming control technique, and output-based grid-forming control technique.

Therefore, the grid-forming control technique according to an embodiment of the disclosure may improve frequency stability by outputting the output at a constant level.

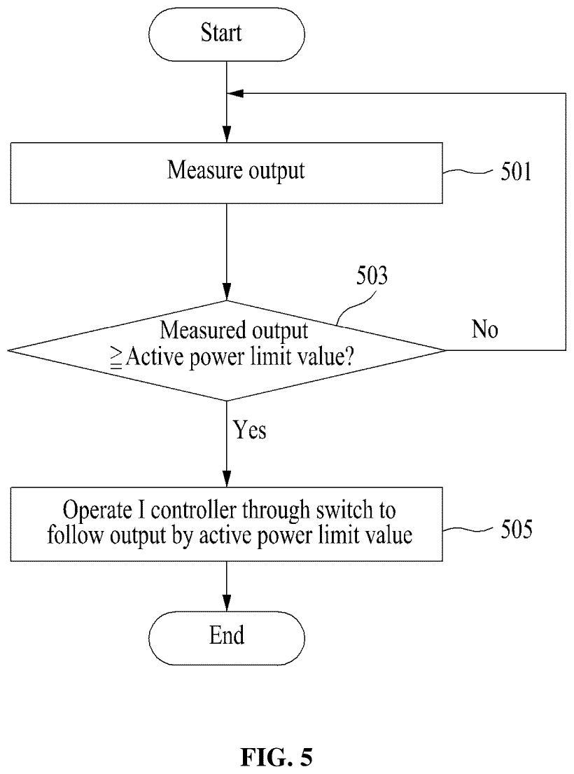

FIG. 5 is a flow chart illustrating output control in a grid-forming inverter according to an embodiment of the disclosure.

Referring to FIG. 5, a grid-forming control unit 103 of the grid-forming inverter measures active power in 501.

For example, the grid-forming control unit 103 may calculate active power and reactive power using an output voltage and output current output in real time from the grid-forming inverter through a power calculation unit.

In 503, the grid-forming control unit 103 compares the measured active power with an active power limit value. As a result of the comparison, if the measured active power is greater than or equal to the active power limit value, proceeding to 505 is made, or otherwise, step 501 is repeated. For example, the active power limit value may be set through mathematical equation 1.

In 505, the grid-forming control unit 103 operates an integral controller through a switch to track the active power to the active power limit value.

For example, a first droop unit may filter the active power through a low-pass filter to generate filtered active power, and output the filtered active power to an active power difference calculation unit and the integral controller 203.

In addition, the integral controller 203 may receive the filtered active power from the low-pass filter and output the filtered active power to an active power comparison unit. The integral controller 203 may determine an active power limit difference by subtracting the filtered active power from a preset active power limit value through the active power comparison unit, and may output the determined active power limit difference to a switch connection unit.

If the active power limit difference is 0 or negative through the switch connection unit, the integral controller 203 determines that the measured active power is greater than or equal to the active power limit value, and turns on the switch to connect between the active power comparison unit and an active power integrator, and may output the active power limit difference to the active power integrator. In addition, the integral controller 203 may accumulatively calculate the active power limit difference through the active power integrator, and output the accumulatively calculated active power limit difference to the frequency calculation unit.

In addition, the first droop unit may determine the active power difference by subtracting the filtered active power from a pre-specified active power setting value P* through the active power difference calculation unit, and output the determined active power difference to a first droop control unit 205. In addition, the first droop unit may generate a compensated active power difference by applying a variable active power droop gain to the active power difference determined through the first droop control unit 205, and output the compensated active power difference to the frequency calculation unit. For example, the variable active power droop gain may be calculated using mathematical equation 2.

In addition, the first droop unit may determine an output frequency by adding a resonance angular frequency ω₀ and a compensated active power difference and an accumulatively calculated active power limit difference through the frequency calculation unit, and output the determined output frequency to the frequency integrator. In addition, the first droop unit may determine a phase angle θ by integrating the output frequency through the frequency integrator, and output the determined phase angle to a voltage control unit.

That is, when the filtered active power is greater than or equal to the active power limit value, the phase angle is determined by considering the accumulatively calculated active power limit difference, thereby enabling the active power to gradually follow the active power limit value.

Through the above process, an embodiment of the disclosure may prevent overcurrent in a grid-forming inverter and improve the stability of a power system. In addition, an embodiment of the disclosure may prevent overcurrent in a grid-forming inverter and provide stable output to improve the frequency stability of a power system.

The description of the disclosure is for illustrative purposes, and those skilled in the art will understand that it can be easily modified into other specific forms without changing the technical idea or essential features of the disclosure. Therefore, the embodiments described above should be understood as being exemplary in all respects and not limiting. For example, each component described as a single type may be implemented in a distributed manner, and likewise, components described as distributed may be implemented in a combined form.

The scope of the disclosure is indicated by the following claims, and all changes or modifications derived from the meaning and scope of the claims and their equivalent concepts should be interpreted as being included in the scope of the disclosure.

1. An apparatus to prevent overcurrent in a grid-forming inverter, the apparatus comprising:
a power calculation unit to measure active power and reactive power at a connection point in real time;
a second droop unit to determine a voltage setting value of the grid-forming inverter by using the reactive power; and
a first droop unit to determine a phase angle of the grid-forming inverter so that the active power follows a predetermined active power limit value if the predetermined active power limit value is lower than or equal to the active power.

2. The apparatus of claim 1, wherein the predetermined active power limit value is set based on a d-axis voltage of the connection point, a q-axis voltage of the connection point, a d-axis current limit value of the grid-forming inverter, a q-axis current limit value of the grid-forming inverter, a current limit value of the grid-forming inverter, and the reactive power.

3. The apparatus of claim 1, wherein the first droop unit comprises:
a low-pass filter to filter the active power and output a filtered active power;
an integral controller that is directly connected to the low-pass filter and a frequency calculation unit and configured to output an active power limit difference accumulatively calculated based on the filtered active power and a predetermined active power limit value;
an active power difference calculation unit that is directly connected to the low-pass filter and configured to determine an active power difference by subtracting the filtered active power from a predetermined active power setting value;
a first droop control unit that is directly connected to the active power difference calculation unit and configured to determine a corrected active power difference by applying a variable active power droop gain to the active power difference;
a frequency calculation unit that is directly connected to the first droop control unit and the integral controller and configured to determine an output frequency by adding a resonance angular frequency, the corrected active power difference, and the active power limit difference; and
a frequency integrator that is directly connected to the frequency calculation unit and configured to determine the phase angle by integrating the output frequency.

4. The apparatus of claim 3, wherein the integral controller comprises:
an active power comparison unit that is directly connected to the low-pass filter and configured to determine the active power limit difference by comparing the filtered active power with the predetermined active power limit value;
a switch connection unit that is located between the active power comparison unit and an active power integrator and configured to connect the active power comparison unit and the active power integrator by using a switch if the predetermined active power limit value is lower than or equal to the filtered active power; and
the active power integrator that is directly connected to the switch connection unit and configured to accumulatively calculate the active power limit difference and output the active power limit difference to the frequency calculation unit.

5. The apparatus of claim 3, wherein the variable active power droop gain is set based on power system impedance, a power system voltage, a voltage of the connection point, a cutoff frequency, an impedance phase angle, an active power droop gain and a reactive power droop gain to prevent overshoot.

6. A method for preventing overcurrent in a grid-forming inverter, the method comprising:
measuring, by a power calculation unit, active power and reactive power at a connection point in real time;
determining, by a second droop unit, a voltage setting value of the grid-forming inverter by using the reactive power; and
determining, by a first droop unit, a phase angle of the grid-forming inverter so that the active power follows an active power limit value if a predetermined active power limit value is lower than or equal to the active power.

7. The method of claim 6, wherein the predetermined active power limit value is set based on a d-axis voltage of the connection point, a q-axis voltage of the connection point, a d-axis current limit value of the grid-forming inverter, a q-axis current limit value of the grid-forming inverter, a current limit value of the grid-forming inverter, and the reactive power.

8. The method of claim 6, wherein the determining of the voltage setting value of the grid-forming inverter comprises:
filtering, by a low-pass filter, the active power and outputting a filtered active power;
determining, by an active power calculation unit, an active power difference by subtracting the filtered active power from a predetermined active power setting value;
determining, by a first droop control unit, a corrected active power difference by applying a variable active power droop gain to the active power difference;
outputting, by an integral controller, an active power limit difference accumulatively calculated based on the filtered active power and the active power limit value;
determining, by a frequency calculation unit, an output frequency by adding a resonance angular frequency, the corrected active power difference, and the active power limit difference; and
determining, by a frequency integrator, the phase angle by integrating the output frequency.

9. The method of claim 8, wherein the outputting of the active power limit difference accumulatively calculated comprises:
determining, by an active power comparison unit, an active power limit difference by comparing the filtered active power with the active power limit value;
connecting, by a switch connection unit, the active power comparison unit and an active power integrator using a switch if the active power limit value is lower than or equal to the filtered active power; and
accumulatively calculating, by the active power integrator, the active power limit difference and outputting the active power limit difference to the frequency calculation unit.

10. The method of claim 8, wherein the variable active power droop gain is set based on power system impedance, a power system voltage, a voltage of the connection point, a cutoff frequency, an impedance phase angle, an active power droop gain and a reactive power droop gain to prevent overshoot.
